(19) United States
(12) Patent Application Publication
(10) Pub. No.: US 2026/0119640 A1
(43) Pub. Date: Apr. 30, 2026

(54) FIELD-LEVEL ACCESS CONTROL

(71) Applicant: DevRev, Inc., Palo Alto, CA (US)

(72) Inventors: Mahesh Medam, Bengaluru (IN); Heer Ambavi, Ahmedabad (IN); Devanshu Shah, Nagpur (IN); Akanksha Deswal, Bangalore (IN); Steven Poitras, Austin, TX (US)

(73) Assignee: DevRev, Inc., Palo Alto, CA (US)

(21) Appl. No.: 19/371,536

(22) Filed: Oct. 28, 2025

(30) Foreign Application Priority Data
Oct. 30, 2024 (IN) 202411083391

(51) Int. Cl. G06F 21/44

(52) U.S. Cl. CPC G06F 21/44

(57) ABSTRACT

Techniques for orchestrating field-level access control in distributed microservices environments are disclosed. An interceptor module embedded within each microservice intercepts incoming requests before they reach the application logic. The interceptor identifies the requesting actor, retrieves relevant field-level access control policies, and evaluates them to determine granular field-level permissions. Requests are only authorized to proceed if the actor has appropriate field-level access. The interceptor also filters outgoing responses to remove any fields the actor lacks permission to view. The system utilizes a distributed cache to store policies and permissions, improving performance. Policies can include tenant identifiers, caveats expressed in a domain-specific language, target resource types, and granular field privileges. This approach enables fine-grained, context-aware access control that can adapt to complex multi-tenant environments while maintaining high performance in distributed architectures.

### RELATED APPLICATION DATA

This application claims priority to, and benefit of, Indian Patent Application number 202411083391 filed on Oct. 30, 2024. The entire disclosure of the above application is expressly incorporated by reference herein.

### TECHNICAL FIELD

The subject matter of the present invention relates to field-level access control. The subject matter described herein, in general, relates to methods and systems for managing field-level access control in microservices architectures in a distributed environment.

### BACKGROUND

Distributed computing environments and microservices architectures have become fundamental to modern software systems, enabling organizations to build scalable and flexible applications. Microservices architectures break down complex systems into smaller, independent services that communicate via Application Programming Interfaces (APIs). As these systems handle sensitive and regulated data, access control mechanisms are applied to ensure data protection. Field-level access control allows for granular protection of data, enabling organizations to restrict access to specific attributes within data objects. The field-level access control is essential for enhancing data security and complying with stringent data privacy regulations.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1 illustrates schematics of a system for orchestrating access control in a distributed environment, in accordance with an example of the present subject matter;

FIG. 2 illustrates a block diagram of a system for orchestrating access control in a distributed environment, in accordance with an example of the present subject matter;

FIG. 3 illustrates a block diagram of a computing system suitable for implementing an embodiment of the present subject matter.

FIG. 4 illustrates a block diagram of a method for orchestrating access control in a distributed environment, in accordance with an example implementation of the present subject matter;

FIG. 5 illustrates a non-transitory computer-readable medium for orchestrating access control in a distributed environment, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern distributed environments, particularly those operating in multi-tenant environments, managing access control at a granular level presents significant challenges. Traditional role-based access control (RBAC) or attribute-based access control (ABAC) systems often fall short when it comes to providing fine-grained control over individual fields within objects across distributed microservices.

In distributed environments, access control mechanisms face various challenges related to performance, consistency, and scalability. The high volume of inter-service communications and the dynamic nature of microservices deployments require access control mechanisms that can make rapid and context-aware decisions without introducing significant latency or becoming bottlenecks in the overall system architecture. The multi-tenancy aspect in the distributed environments further complicates the scenario. In multi-tenant environment, each tenant may have its own unique set of access control requirements, necessitating a flexible policy definition framework that can accommodate diverse needs without requiring changes to the underlying system architecture. This flexibility must be balanced with the need for a consistent and manageable policy enforcement mechanism across the entire distributed environment.

Conventional field-level access control systems for distributed environments typically rely on centralized authorization services. In the conventional field-level access control systems, a dedicated authorization service acts as the single source for accessing control decisions across the entire distributed system. When a user or service requests to access a resource or an object to read or modify it, the request is first routed to the centralized authorization service. The centralized authorization service evaluates the request against stored policies, considering factors like the user's role and the resource being accessed, before returning an allow or deny decision to the user or the service.

With the shift of organizations towards microservices architectures, adaptations have emerged like deploying multiple authorization service instances or implementing service mesh patterns. However, the conventional techniques still fundamentally rely on separate, centralized services for field-access control decisions. Despite widespread adaptations, conventional centralized field-level access control systems face significant challenges in modern distributed environments, particularly microservices architectures. The reliance on a central authorization service creates a potential performance bottleneck, especially problematic in high-throughput scenarios where a single user request may trigger multiple inter-service calls each requiring authorization. The network overhead from constant communication with the central authorization service introduces latency and increases overall network load.

In conventional field-level access control systems, the centralized authorization service also represents a single point of failure that can severely impact system availability. Further, scalability is limited, as the authorization service often doesn't scale linearly with the rest of the microservices ecosystem. Consequently, implementing and enforcing intricate policies efficiently in the conventional field-level access control systems remains challenging. Conventional systems with centralized authorization services often lack full context awareness of specific service environments, limiting nuanced decision-making. Additionally, for frequent inter-service communications, consulting the central authorization service for each API call introduces significant cumulative latency. Conventional approaches struggle to keep pace with dynamic cloud environments where services are rapidly deployed, scaled, or decommissioned. The constant need to consult the central authorization service leads to inefficient resource utilization, particularly for frequently accessed services or data.

The challenge is further aggravated in providing the granular level of access control in multi-tenant systems. In multi-tenant systems, where multiple organizations or “tenants” share the same application instance, the access control requirements can vary significantly between tenants. Each tenant may have unique organizational structures, roles, and security policies. Conventional field-level access control systems often lack the flexibility to accommodate these diverse needs without extensive customization or compromises. For instance, one tenant might require that all employees can view customer names and contact information, while another tenant may need to restrict contact information to only senior staff members. Implementing these varied requirements across tenants becomes increasingly complex and error-prone without a flexible and efficient field-level access control system. In addition, while the principle of least privilege is a fundamental security concept, implementing it effectively at a field-level across the distributed system is extremely difficult with conventional centralized approaches.

The present subject matter envisages techniques for orchestrating access control in a distributed environment. According to one exemplary embodiment, the present subject matter facilitates managing field-level access control for microservices in the distributed environment. In an example implementation, an interception mechanism that operates within individual microservices may be employed. For instance, the interception mechanism may include an interceptor module acting as a sentinel, examining and controlling both incoming requests in a microservice and outgoing responses from the microservice. In an example, the interceptor module may be embedded within each microservice amongst a plurality of microservices in the distributed environment.

In an example implementation, an incoming request is received by a microservice. The incoming request may be a read operation, a write operation, or a combination of both, associated with an object. The object may be products, customers, orders, employees, users, and so on. Examples of such incoming request include, but are not limited to, a GET request to retrieve customer information, a POST request to create a new order, a PUT request to update an existing product which requires reading the current state and writing the updated state, a GET request to retrieve specific fields of an employee record, a PATCH request to update only the email address of a user, etc.

In an example, instead of allowing the incoming request to directly reach the microservice's main application logic, the interceptor module may intercept it for evaluation. Upon interception, an actor associated with the request may be identified. In an example, the actor may be an end-user, a service account, or another microservice making an inter-service call. Examples of the end-user include, but are not limited to, a customer logging into an e-commerce website to view their order history, an employee accessing a company's HR portal to update their personal information, a bank account holder checking their account balance through a mobile application, etc. Examples of the service account include, but are not limited to, an automated backup system accessing database records to create periodic backups, a monitoring service collecting performance metrics from various microservices, etc. Examples of another microservice include, but are not limited to, an order processing microservice requesting customer details from a customer management microservice, an inventory management microservice querying a product catalog microservice for product information, etc. The identification process may include extracting and validating authentication tokens or credentials included in request headers associated with the request.

Once the actor is identified, a relevant field-level access control policy is retrieved for that specific actor. In an example, the field-level access control policy may define complex rules and conditions that may determine an actor's access rights at the field level of the object. For instance, the rules may consider various factors such as the actor's role, the time of the request, the data's sensitivity, or any other contextual attributes relevant to the access decision. In an example, the field-level access control policy may have a complex structure including multiple attributes, such as a tenant identifier, a set of caveats, a resource type, and a field privilege.

In an example, the tenant identifier uniquely identifies the organization or department to which the policy applies. For example, in a multi-tenant system, “Tenant A” may represent a specific company using the shared application, while “Tenant B” may represent a different organization with its own distinct set of policies. In an example, the set of caveats defines conditional rules that determine when the policy should be applied. For instance, a caveat may specify “Access Time between (9:00, 17:00)” to restrict access to business hours only, or “User Location equals (‘Head Office’)” to limit access to users physically present at the company's main location. In an example, the resource type specifies the kind of data object the policy governs. Examples may include “Customer”, “Invoice”, or “Employee Record”, each representing different types of data within the system that may require distinct access controls. In an example, the field privileges define the specific read or write permissions for individual fields within the resource type. For example, for a “Customer” resource type, field privileges might include “READ: name, email” and “WRITE: address, phone”, allowing certain actors to view a customer's name and email while only permitting updates to their address and phone number.

The retrieved field-level access control policy may then be evaluated against the context of the current request. The evaluation results in a determination of field-level access permission. In an example, the field-level access permission may be a granular map illustrating specific fields within the requested object for which the actor is allowed to read or write. Based on the evaluation, an authorization decision is made. If the request is authorized, it is allowed to proceed to the microservice's main application logic for processing. The microservice's main application logic may process the request and may accordingly generate a response. However, if the request is not authorized based on the retrieved field-level access control policy, it may not be allowed to proceed to the microservice's main application logic. This mechanism allows the core application logic of the microservice to operate without being burdened by access control concerns, thereby promoting a separation of concerns in the system architecture.

In an example implementation, after the microservice application logic processes the request and generates the response, the generated response may be intercepted before it's sent back to the requester or the actor. The interception of the response is crucial for maintaining consistent access control throughout the entire request-response cycle. In an example, the generated response may be filtered based on the previously determined field-level access permission. For instance, any field in the response that the actor lacks permission to access may be removed. The filtering of the generated response ensures that even if the microservice's application logic retrieves or modifies data beyond what the actor is allowed to see, the final response only contains information the actor is authorized to access.

The embodiments of the present subject matter describe a comprehensive and efficient approach to manage field-level access control in distributed microservices architectures. The field-level access control system for distributed environments offers significant technical advantages. The present subject matter allows organizations to define policies that restrict access not just at the object level but down to individual fields within the object, thereby ensuring extremely fine-grained control over data access. This granularity is particularly valuable in scenarios where different parts of an object may have different sensitivity levels or regulatory requirements.

The field-level access control policy structure, with its tenant identifier, caveats, target resource type, and field privileges, allows for highly nuanced and context-aware access control decisions. This is a significant improvement over traditional role-based or attribute-based access control systems, which often lack the ability to make fine-grained, context-dependent decisions. The set of caveats enable the creation of complex, conditional access rules that can consider a wide range of factors. The incorporation of tenant identifiers into the policy allows for efficient management of field-level access control in environments where multiple organizations or departments share the same underlying infrastructure. In such scenarios, each tenant may have its own set of policies, tailored to its specific needs and regulatory requirements, without affecting others.

The present subject matter aligns well with modern distributed architectures by operating at the microservice level. It allows for decentralized policy enforcement, which can enhance performance by reducing the need for constant communication with a central authorization service. The design of the present technique also improves scalability, as each microservice instance can independently enforce access control policies. By embedding the interceptor module within each microservice, the system achieves high-performance, fine-grained access control without the bottlenecks and latency issues associated with centralized authorization systems.

The present subject matter's focus on minimizing authorization latency has a profound impact on overall system performance, especially considering that authorization checks occur for every API call, including inter-service communications. By keeping authorization checks fast and distributed, the system significantly reduces the time added to each API call for field-level access control. This results in quicker response times for end-users and improved throughput for the system as a whole. In microservices architectures, services often need to communicate with each other to fulfill requests. The low-latency authorization checks ensure that these inter-service calls are not bogged down by slow access control mechanisms, maintaining the agility and responsiveness of the distributed system. Further, for user-facing applications, the reduced latency translates directly to a more responsive and fluid user experience. This may be particularly advantageous for applications that require real-time data updates or frequent API calls.

Additionally, the two-stage interception process in the present technique, i.e., at both request and response, ensures comprehensive protection. It prevents unauthorized data modifications on the input side and unauthorized data leakage on the output side. This dual-layer protection is crucial in maintaining data integrity and confidentiality throughout the entire transaction process.

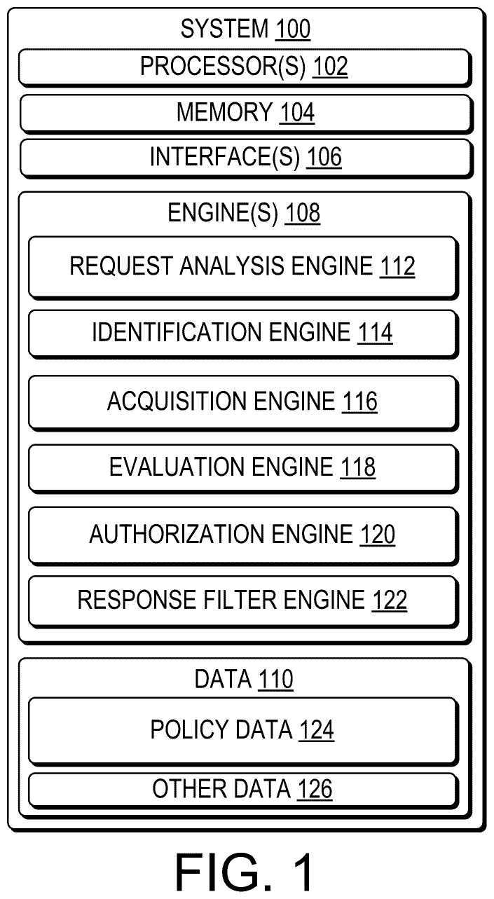

The present subject matter is further described with reference to FIGS. 1-5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates schematics of a system 100 for orchestrating access control in a distributed environment, in accordance with an example of the present subject matter. The system 100 may include a processor(s) 102 to run at least one operating system and other applications and services. The system 100 may further include a memory 104 coupled to the processor(s) 102, interface(s) 106, engine(s) 108, and data 110.

The processor(s) 102, amongst other capabilities, may be configured to fetch and execute computer-readable instructions stored in the memory. The processor(s) 102 may be implemented as one or more microprocessors, microcomputers, microcontrollers, digital signal processors, central processing units, state machines, logic circuitries, and/or any devices that manipulate signals based on operational instructions. For instance, the processor(s) 102 may include specialized AI accelerators or Graphic Programming Units (GPUs) optimized for machine learning tasks. The functions of the various elements shown in the figure, including any functional blocks labelled as “processor(s)” or “processing unit”, may be provided through the use of dedicated hardware as well as hardware capable of executing machine readable instructions.

When provided by the processor(s) 102, the functions may be provided by a single dedicated processor, by a single shared processor, or by a plurality of individual processors, some of which may be shared. Moreover, explicit use of the term “processor(s)” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. For example, the system 100 may utilize FPGAs for real-time data processing and ASICs for specific, high-performance tasks like encryption or data compression. Other hardware, conventional and/or custom, may also be included. The processor(s) 102 may include routines, programs, objects, components, data structures, and the like, which perform particular tasks or implement particular abstract data types. The processor(s) 102 may further include modules that supplement applications on the system 100, for example, modules of an operating system. Further, the processor(s) 102 may be implemented in hardware, instructions executed by a processing unit, or by a combination thereof.

The memory 104 may be coupled to the processor(s) 102 and may, among other capabilities, provide data and instructions for performing different functions. The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 104 may store the information received and in possession of the system 100 as data 110.

The interface(s) 106 may include a variety of machine-readable instructions-based interfaces and hardware interfaces that allow the system 100 to interact with different components, such as the processor(s) 102, the memory 104, the engines 108, and the data 110. Further, the interface(s) 106 may enable the system 100 to communicate with computing devices, for example, the computing devices in discrete ecosystems may communicate with the system 100, web servers, and external repositories. The interface(s) 106 may facilitate multiple communications within a wide variety of networks and protocol types, including wireless networks, wireless Local Area Network (WLAN), RAN, satellite-based network, and the like. For instance, the interface(s) 106 may support protocols such as Hyper Text Transfer Protocol Secure (HTTPs, Message Queuing Telemtry Transport (MQTT) for, and Remote Procedure Calls (RPCs).

The engine(s) 108 may be implemented as a combination of hardware and firmware or software. In examples described herein, such combinations of hardware and firmware may be implemented in several different ways. For example, the firmware for the engine(s) 108 may be processor executable instructions stored on a non-transitory computer-readable storage medium and the hardware for the engine(s) 108 may include a processing resource (for example, implemented as either a single processor or a combination of multiple processors), to execute such instructions.

In the present examples, the machine-readable storage medium may store instructions that, when executed by the processor(s) 102, implement the functionalities of the engine(s) 108. In such examples, the system 100 may include the machine-readable storage medium storing the instructions and the processor(s) 102 to execute the instructions. In other examples of the present subject matter, the machine-readable storage medium may be located at a different location but accessible to the system 100 and the processor(s) 102. The engine(s) 108 may include a request analysis engine 112, an identification engine 114, an acquisition engine 116, an evaluation engine 118, an authorization engine 320, and a response filter engine 122 coupled with each other.

The system 100 may further include data 110, that serves, amongst other things, as a repository for storing data that may be fetched, processed, received, or generated by the engine(s) 108. The data 110 may include policy data 124 and other data 126. In an example, the data 110 may be stored in the memory 104.

In an example implementation, the system 100 may receive an incoming request. The incoming request may be received in a microservice in a distributed environment. The incoming request may be a read request or a write request or a combination of both, associated with an object within the system 100. In an example, the read request may include retrieving data from the object. In another example, the write request may include modifying or updating the object's data.

Upon receiving the incoming request, the request analysis engine 112 may intercept the incoming request. The incoming request may be intercepted to examine and evaluate the request. In an example, the interception process initiates as soon as the request reaches the microservice's entry point. This early interception is vital because it allows the system to enforce security measures before any potentially sensitive operations or data accesses occur within the microservice's main logic. The early interception may also allow for the immediate rejection of unauthorized requests, preventing unnecessary processing and potential security breaches. For instance, the early interception may be particularly important in write operations, where unauthorized modifications may have significant adverse consequences if allowed to reach the application logic.

In an example implementation, the identification engine 114 may identify an actor associated with the incoming request. In an example, an entity making the incoming request may be referred to as the actor. The actor, in this context, can take various forms. The actor may be an end-user accessing the system through a user interface, or a service account used by another application or system to interact with the microservice, or another microservice within the same distributed environment making an inter-service call. The identification of the actor is essential as all subsequent authorization decisions will be based on the permissions and policies associated with the identified actor. The identification engine 114 may use different types of authentication mechanisms, such as a token-based authentication, a session-based authentication, API keys, and other methods to identify the actor.

In an example, the actor may be identified through the examination of authentication tokens or credentials included in the request headers. The incoming request may include an authentication token, often in the form of a JSON Web Token (JWT). The authentication token, which is usually obtained when the actor initially authenticates with the system, may include encoded information about the actor's identity and potentially other relevant attributes associated with the actor. In an example, the identification engine 114 may locate the authentication token placed at a predefined location within the request headers. Once located, the identification engine 114 may validate the token to ensure its authenticity and integrity. For example, the validation process may include verifying the token's digital signature using a shared secret or public key, depending on the token signing method employed by the authentication system. The identification engine 114 may also check if the token has expired, as most authentication tokens have a limited lifespan for security reasons.

If the token is successfully validated, the identification engine 114 may then decode its contents to extract the actor's identity. The identity may include a unique identifier for the actor, such as a user ID or service account name. Depending on the token's structure and the information included by the authentication system, it may also contain additional details such as the actor's roles, permissions, or other attributes that could be relevant for access control decisions.

In some scenarios, particularly for inter-service communications within a microservices architecture, the identification process may involve different mechanisms. For instance, services may use mutual TLS (mTLS) authentication, where each service has its own certificate. In such scenarios, the identification engine 114 may verify the client certificate presented with the request to identify the calling service.

In multi-tenant environments, the actor identification process becomes even more critical. The identification engine 114 not only needs to identify the individual actor but also determine which tenant the actor belongs to. The tenant information is important for applying the correct set of access control policies, as each tenant may have its own unique security requirements and policy configurations.

In an example implementation, the acquisition engine 116 retrieves a relevant field-level access control policy for the identified actor. The field-level access control policy may determine an actor's permissions to access specific fields within data objects in the microservices architecture. The field-level access control policy provides granular control over data access in multi-tenant environments. In an example implementation, in the multi-tenant environment, each tenant may include a group of actors called admins who can configure policies for their tenant. The admins may create new policies, edit and delete existing policies, and assign and revoke these policies from actors.

Further, each field-level access control policy is associated with several key attributes that define its scope and applicability. In an example, the attributes may include one or more of a tenant identifier, a set of caveats, a target resource type, and a field privilege. The attributes create a flexible and powerful mechanism for enforcing fine-grained access control across distributed systems.

In an example, the tenant identifier may be indicative of a fundamental aspect of the field-level access control policy, reflecting the multi-tenant nature of the system. In modern cloud-based applications and services, it's common for multiple organizations or “tenants” to share the same underlying infrastructure and application instances. The tenant identifier ensures that the policies are scoped to specific tenants, allowing each organization to maintain its own set of access control rules without interfering with or compromising with the security of other tenants. This separation is crucial for maintaining data isolation and compliance with various regulatory requirements that mandate strict control over data access and privacy.

In an example, the set of caveats within the field-level access control policy represents conditions or rules that must be satisfied for the policy to be applied. The set of caveats adds a layer of context-awareness to the field-level access control system, allowing for dynamic and flexible policy enforcement based on various factors. In an example implementation, the policy may include proprietary caveat Domain-Specific Language (DSL) that enables the definition of conditional read and write access to fields for a given actor. The DSL allows administrators to create complex, context-dependent access rules that can take into account various factors such as user attributes, time of day, location, or any other relevant contextual information. For example, a policy could be created that grants access to sensitive financial fields only during business hours and from approved IP addresses. Further, the incorporation of caveats in the policy may allow for nuanced, condition-based access decisions. The caveats may be evaluated as boolean expressions, and field privileges may be granted only if all the caveats in a policy are evaluated to be true. Such conditional access mechanism enables the implementation of complex access scenarios that may adapt to changing contexts or business rules.

In an example, the target resource type, specified in the field-level access control policy, indicates the type of data object or entity to which the policy applies. For instance, the target resource type may be a database table, an API endpoint, a document type, or any other categorization of data within the system. By specifying the resource type, the field-level access control policy can be efficiently applied to the relevant data objects without unnecessary evaluation for unrelated resources. Such a targeted approach contributes to the overall performance and scalability of the filed-level access control system.

In an example, field privileges may define specific permissions granted for individual fields within the resource type. The field privileges typically include read and write permissions, allowing for fine-grained control over which fields an actor can view or modify. The field-level access control policy may grant access to all fields, a subset of fields, or no fields at all, depending on the level of access required for the actor. This granular approach to field-level permissions enables organizations to implement the principle of least privilege effectively, ensuring that actors have access only to the specific data fields necessary for their roles and responsibilities.

For example, a sample field-level access policy that grants read and write access to fields may be as shown below:

```
  {
    “dev_oid”: “ ”,
    “caveats”: [
      {
        “key”: “ ”,
        “operator”: “ ”,
        “vals”: “ ”,
        },
        ...
  ],
  “target”: “ ”,
  “field_privileges”: {
    “read”: {
      “all”: true/false,
      “fields”: [...],
    },
    “write”: {
      “all”: true/false,
      “fields”: [...]
    }
  }
}
```

In the above example “dev_oid” represents the ID of the tenant, “caveats” represents the conditions under which the field privileges are applied, “target” represents the resource type on which the policy is applied, and “field_privileges” contain the field access granted by the policy when caveats are satisfied.

The evaluation engine 118 may then evaluate the retrieved relevant field-level access control policy for the identified actor. In an example, the details of the incoming request may be compared against the rules and conditions specified in the retrieved policy. The evaluated field-level access control policy may include a comprehensive set of permissions dictating which fields the identified actor can read or write within the specified resource type. This information may then be used by the system to enforce these permissions on incoming requests and outgoing responses.

In an example, during the evaluation for read request, the evaluation engine 118 may determine which fields the actor is allowed to view based on the policy. In another example, during the evaluation for write request, the evaluation engine 118 may determine whether the actor has permission to modify specific fields in the request payload. In write requests, the evaluation engine 118 may perform a detailed inspection of the request payload. This inspection process involves parsing and analyzing the content of the request to identify precisely which fields within the target object are being modified. This granular level of inspection allows the system to make highly specific access control decisions based on individual fields rather than applying blanket permissions to entire objects or resources. The evaluation engine 118 may identify which specific fields are being modified in the request and may compare them against the write permissions determined from the policy evaluation. If the actor lacks permission to modify any of the specified fields, the entire request is rejected before it reaches the microservice's main logic. This early rejection mechanism is an important security feature that may prevent unauthorized data modifications, thereby reducing unnecessary processing of invalid write requests.

In an example, for policy enforcement, an actor, by default, may have no access to any fields unless explicitly granted through policies. This “deny by default” approach aligns with the principle of least privilege, ensuring that access is only granted when specifically allowed by a policy. During evaluation, the system may start from the baseline of no access and may build up the permissions based on the applicable policies. In another example, when multiple policies are applicable to an actor for the same target, the system aggregates the field privileges from all relevant policies. This additive approach to policy evaluation allows for flexible and granular access control configurations that can accommodate complex organizational hierarchies and role structures.

The evaluation engine 118 also handles scenarios of conflicting or overlapping policies. In cases where multiple policies apply to the same fields but specify different permissions, the system employs predefined resolution strategies. These strategies may prioritize more specific policies over general ones, or may apply the most restrictive permissions in case of conflicts. The exact resolution strategy can be configured based on the organization's security requirements and operational needs.

Based on the determined field-level access permission, the authorization engine 120 may authorize the request to proceed to the microservice application logic. In an example, when authorizing the request to proceed, the authorization engine 120 may also attach metadata to the request. The metadata may include information about the actor's permissions, which can be useful for the microservice application logic in making further access control decisions or optimizing its operations based on what the actor is permitted to do.

The authorization step may also help in maintaining the principle of least privilege. By carefully controlling which requests are allowed to proceed based on fine-grained field-level permissions, the system ensures that actors only have access to the minimum amount of data necessary to perform their tasks. This significantly reduces the risk of unauthorized data access or manipulation. Further, in scenarios where a request is not authorized to proceed, the authorization engine 120 may respond with an appropriate error message or status code. This feedback may help the actor in understanding why their request was denied. Consequently, the actor may potentially adjust their request or seek the necessary permissions. In an example, each authorization decision can be logged, providing a detailed record of who attempted to access what data and whether the access was granted. The logged information may further be used in security audits, compliance reporting, and investigating potential security incidents.

Upon authorization, the microservice application logic may process the incoming request, which may involve retrieving data from databases, performing computations, or modifying existing data. The result of processing the request may include a response that contains the requested information or confirmation of the requested action. However, in some scenarios, the generated response may include data that the requesting actor is not authorized to access according to the field-level access control policies.

In an example implementation, before the generated response is sent back to the requesting actor, the request analysis engine 112 may intercept the response. The primary purpose of this interception is to ensure that the data being returned adheres to the access control policies defined for the specific actor making the request. By intercepting the generated response, the request analysis engine 112 gains an opportunity to apply the necessary access control measures before the data leaves the microservice boundary. The response filter engine 122 may then filter the response to remove fields that the actor lacks permission based on the determined field-level access permissions. The filtering technique ensures that even if unauthorized data is accidentally processed or retrieved, it may not reach the end-user or calling service, thus maintaining data security and privacy throughout the entire request-response cycle.

In an example, for a read request, the response may include various fields or attributes of requested objects. In a customer management system, for instance, the response may contain a customer's full profile, including name, contact information, financial details, and internal notes. The interception of the response may allow the system to filter out any fields that the requesting actor is not authorized to view before the data is sent back.

In another example, for a write request, the response may indicate the success or failure of the requested modification and may include the updated data. Intercepting the response may allow the system to verify that the modifications were applied only to fields the actor had permission to change, and may help in ensuring that any returned data reflects only the fields the actor is authorized to view.

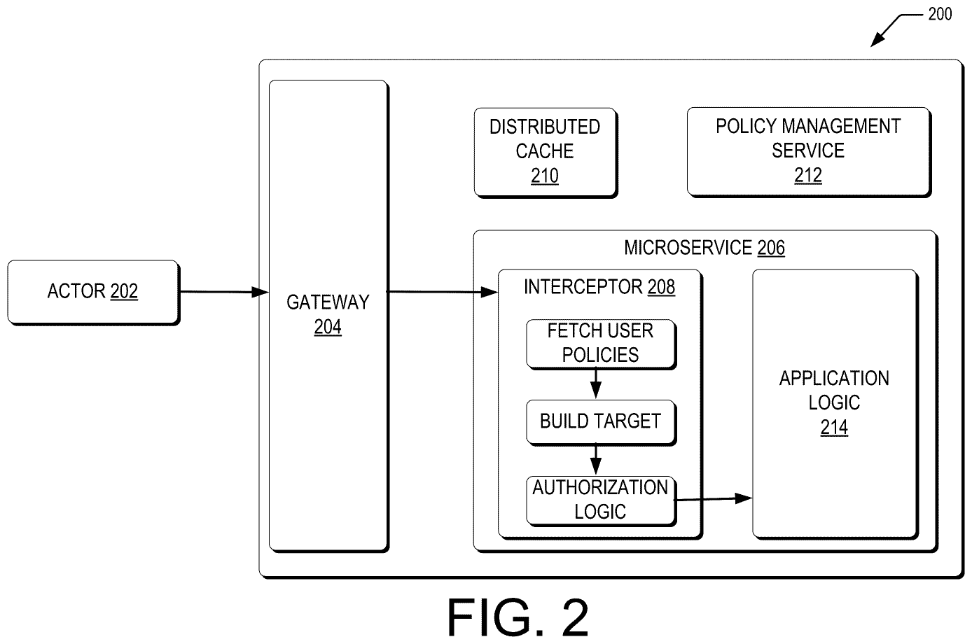

FIG. 2 illustrates a block diagram of a system 200 for orchestrating access control in a distributed environment, in accordance with an example of the present subject matter. The system 200 may correspond to the system 100. Further, the engine(s) 108 of the system 100 may correspond to an interceptor 208 of the system 200. The system 200 for orchestrating access control in the distributed environment comprises several key components that work together to ensure fine-grained field-level access control. The system 200 includes a gateway 204, which serves as the entry point for incoming requests from an actor 202. The gateway 204 may act as a central point of control, routing requests to the appropriate microservices while also playing a crucial role in the overall security architecture.

The system 200 includes a policy management service 212 and a microservice 206. The policy management service 212 is responsible for storing, managing, and providing access to the field-level access control policies. These policies define the granular permissions for different actors regarding their ability to read or write specific fields within the system's data objects. In an example, the policy management service is a centralized repository for accessing field-level access control policies across the distributed environment. The policy management service 212 is designed to be highly efficient and scalable, capable of handling a large number of policies across multiple tenants in a multi-tenant environment.

The microservice 206 may be responsible for handling operations related to object data, such as creating, reading, updating, or deleting object information. A fundamental component within each microservice 206 is an interceptor 208. In an example, the interceptor 208 may be embedded within each microservice 206 in the system 200. The interceptor 208 is a module that exists at the entry point of the microservice 206 and intercepts all incoming requests before they reach a main application logic 214. This interception is crucial for implementing the field-level access control mechanism. The interceptor's 208 primary function is to evaluate whether the incoming request should be allowed to proceed based on the actor's permissions. Thus, the interceptor 208 enforces authorization on every request entering the microservice 206. This strategic positioning of the interceptor 208 allows for access control checks to be performed at the earliest possible point in the request processing pipeline.

The process of handling the incoming request begins when it reaches the interceptor 208. The first step in this process is fetching the user policies. To optimize performance and to reduce latency, the system 200 implements a caching mechanism for these policies. In an example implementation, when a request comes in, the interceptor 208 may first check if the relevant policies are available in a distributed cache 210. If the relevant policies are found in the distributed cache 210, they are immediately retrieved and used for evaluation. This caching mechanism significantly reduces the load on the policy management service 212 and improves the overall response time of the system 200.

However, if the policies are not found in the distributed cache 210, the interceptor 208 may then reaches out to the policy management service 212 to fetch the relevant policies. This ensures that even if the distributed cache 210 doesn't have the most up-to-date policies, the system 200 may still retrieve and apply the correct access controls. Once fetched, these policies may be stored in the distributed cache 210 for future use, further optimizing subsequent requests. To support audit and compliance requirements, the interceptor 208 may log details of each access control decision. These logs capture information about the requester, the accessed resources, the applied policies, and the resulting access decisions. This detailed logging enables comprehensive auditing and helps in identifying potential security issues or policy misconfigurations.

After the policies are obtained, the interceptor 208 proceeds to build the target. This involves gathering the necessary information about the resource being accessed. In the example related to book microservice 206, the information may be book-related information. In an example, the book-related information may be retrieved from data store, such as MongoDB, depending on the system's architecture and requirements.

Once the policies and target information are retrieved, the interceptor 208 may proceed to the authorization evaluation phase where the actual field-level access control takes place. The authorization block within the interceptor 208 may be responsible for this crucial step. It begins by fetching the applicable rules from the policies. The evaluation process follows a hierarchical approach. First, the system checks for object-level access. This means determining whether the actor has the basic permission to perform the requested operation (such as create or read) on the object. If the actor doesn't have this fundamental access, the request is immediately denied without proceeding further. If the actor has the necessary object-level access, the evaluation moves to the next level, i.e. field privileges. This is where the granularity of the field-level access control system is evaluated. The system 200 compares the fields in the request payload against the field privileges defined in the user's policies. It checks whether the actor has the necessary permissions to access or modify each specific field mentioned in the request.

The detailed field-level evaluation ensures that the actors may only interact with the fields they are explicitly authorized to access. For example, an actor may have permission to view a book's title and author but not its price or internal notes. Similarly, for write operations, an actor may be allowed to update certain fields of a book record but not others. If the evaluation determines that the actor doesn't have the necessary field-level permissions for the request, the interceptor 208 may return a “permission denied” response. This prevents unauthorized access or modification of data at a very granular level, enhancing the overall security of the system.

In an example, if the actor has the required permissions, the request is allowed to proceed to the service handler, which contains the main application logic 214 of the microservice 206. The actual business operations, such as retrieving object data from the database, updating records, or performing any other necessary computations are performed in the main application logic 214 of the microservice 206.

An important aspect of the system 200 is that the access control doesn't stop at the request level. After the application logic 214 has processed the request and generated a response, there's another crucial step before sending this response back to the user. The system 200 may perform a final check on the outgoing data to ensure that it only includes information the user is authorized to see. This response filtering process involves re-evaluating the user's read access permissions, which were initially checked at the beginning of the request processing. Based on these permissions, the system 200 prunes the response, removing any fields that the user doesn't have access to. This ensures that even if the application logic 214 retrieves more data than the user is allowed to see (for instance, for internal processing reasons), only the authorized subset of that data is actually sent back to the actor.

This comprehensive approach to access control-checking permissions both at the request and response stages-ensures that the principle of least privilege is maintained throughout the entire request-response cycle. It guarantees that actors only receive the information they are explicitly authorized to access, regardless of what happens in the internal processing of the request.

Moreover, the system 200 is designed to maintain consistent access control even in scenarios involving inter-microservice communication. When one microservice needs to communicate with another to fulfill a request, the same access control principles are applied. This ensures that as data flows between different services within the distributed system, the user's access permissions are consistently enforced. It prevents scenarios where a user might gain access to unauthorized information through indirect means or through the interaction of multiple services.

The implementation of this field-level access control system at the microservice level, through the interceptor module, offers several advantages. The interceptor allows for decentralized enforcement of access control policies, which is crucial in a distributed microservices architecture. Each microservice can independently enforce the relevant access control policies without relying on a centralized authorization service for every request. This decentralized approach significantly improves the system's scalability and performance. By having the interceptor module within each microservice, the system can make quick access control decisions without the need for constant communication with a central authorization service. This reduces latency and eliminates potential bottlenecks that could arise from relying on a single, centralized point for all authorization decisions.

Furthermore, the system's architecture allows for fine-tuned field-level access control that can be tailored to the specific needs and data models of each microservice. While the overall policy structure and evaluation process remain consistent across the system, each microservice can implement access controls that are most appropriate for its particular domain and data.

Additionally, the caching mechanism implemented in the system plays a crucial role in optimizing performance. By caching user policies and potentially even authorization decisions, the system can significantly reduce the load on the policy management service and speed up the authorization process for frequently accessed resources or repeated requests from the same user.

Another key advantage of the system is its ability to handle complex, multi-tenant environments effectively. The policy management service may store and manage policies for multiple tenants, and the interceptor module can apply the correct set of policies based on the tenant context of each request. This multi-tenant capability allows the system to provide customized access control for different organizations or departments sharing the same underlying infrastructure, without compromising the security or privacy of each tenant's data.

The granularity of the field-level access control also provides significant benefits in terms of data privacy and regulatory compliance. Organizations can implement very specific data access policies, ensuring that sensitive information is only accessible to those who absolutely need it. This granular control is particularly valuable in industries with strict data protection regulations, as it allows organizations to precisely control and audit access to personal or sensitive information at the field level. Therefore, the field-level access control system represents an efficient approach to managing data access in distributed, microservices-based environments. By combining policy-based access control, caching mechanisms, and granular field-level permissions, the system provides a robust, scalable, and flexible solution for enforcing the principle of least privilege across complex distributed architectures. The implementation at the microservice level through the interceptor ensures consistent application of access control policies throughout the entire system, enhancing both security and performance in modern, cloud-native applications.

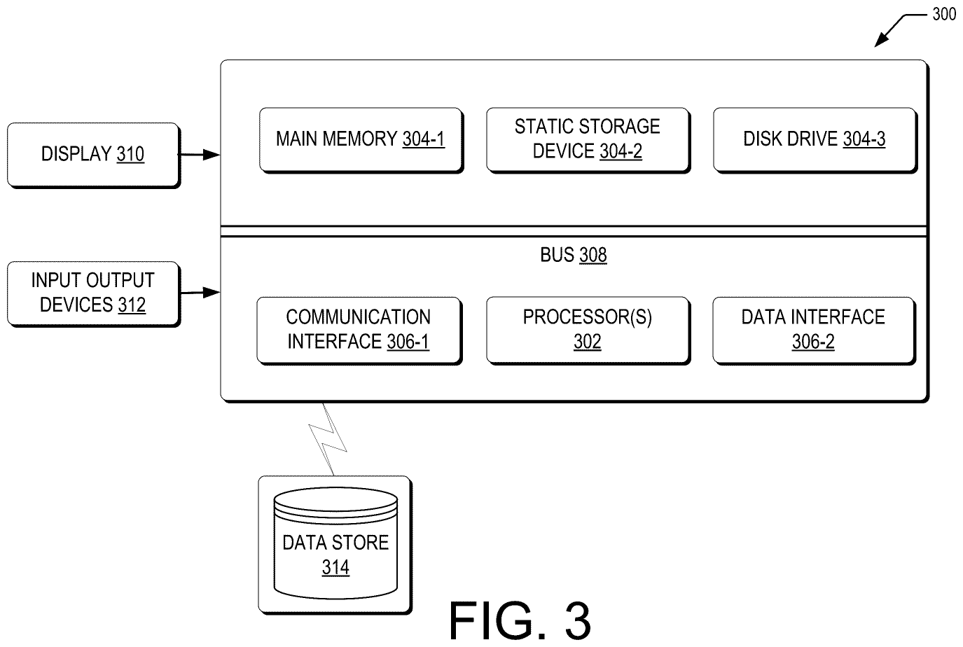

FIG. 3 illustrates a block diagram of a computing system 300 suitable for implementing an embodiment of the present subject matter. Computing system 300 may include a bus 308 or other communication mechanism for communicating information, which interconnects subsystems and devices, such as processor(s) 302, main memory 304-1 (e.g., RAM), static storage device 304-2 (e.g., ROM), disk drive 304-3 (e.g., magnetic or optical), communication interface 306-1 (e.g., modem or Ethernet card), display 310 (e.g., CRT or LCD), input device 312 (e.g., keyboard, and cursor control).

According to one embodiment of the present subject matter, the computing system 300 performs specific operations by the processor(s) 302 executing one or more sequences of one or more instructions contained in the main memory 304-1. Such instructions may be read into the main memory 304-1 from another computer readable/usable medium, such as the static storage device 304-2 or disk drive 304-3. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor(s) 302 for execution. Such a medium may take many forms, including but not limited to, non-volatile media and volatile media. Non-volatile media includes, for example, optical or magnetic disks, such as disk drive 304-3. Volatile media includes dynamic memory, such as main memory 304-1. A data store 314 may be accessed in a computer readable medium using a data interface 306-2.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 300. According to other embodiments of the present subject matter, two or more computing systems 300 coupled by communication link (e.g., LAN, PTSN, or wireless network) may perform the sequence of instructions required to practice the invention in coordination with one another.

The computing system 300 may transmit and receive messages, data, and instructions, including program, i.e., application code, through communication link and communication interface 306-1. Received program code may be executed by the processor(s) 302 as it is received, and/or stored in the disk drive 304-3, or other non-volatile storage for later execution.

In a typical configuration, the computer includes one or more processors (CPU), an input/output interface, a network interface, and a memory. The memory can consist of a non-persistent memory, a random-access memory (RAM), and/or a non-volatile memory in a computer-readable medium, for example, a read-only memory (ROM) or a flash memory (flash RAM). Memory is an example of a computer-readable medium.

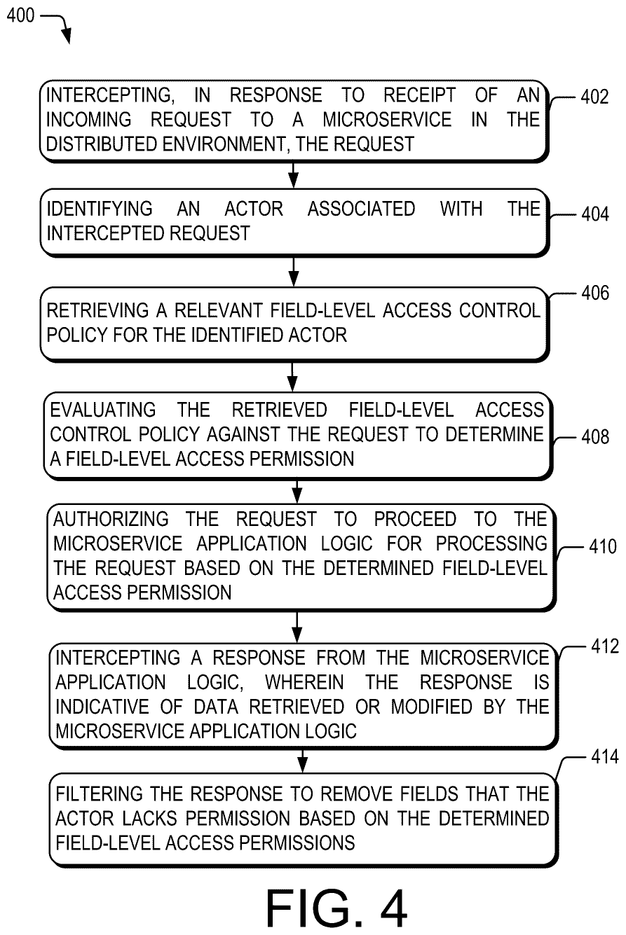

FIG. 4 illustrates a block diagram of a method for orchestrating access control in a distributed environment, in accordance with an example implementation of the present subject matter. Although the method 400 may be implemented in a variety of devices, but for the ease of explanation, the description of the method 400 is provided in reference to the above-described system 100 and 200. The order in which the method 400 is described is not intended to be construed as a limitation, and any number of the described method blocks may be combined in any order to implement the method 400, or an alternative method.

It may be understood that blocks of the method 400 may be performed in the system 100 and 200. The blocks of the method 400 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 402, an incoming request may be received in a microservice in a distributed environment. The incoming request may be a read request or a write request or a combination of both, associated with an object. Upon receiving the incoming request, the request may be intercepted. The incoming request may be intercepted to examine and evaluate the request. In an example, the interception process initiates as soon as the request reaches the microservice's entry point. In an example, the interception process is performed before reaching a microservice application logic.

At block 404, an actor associated with the incoming request may be identified. In an example, an entity making the incoming request may be referred to as the actor. In another example, an end-user, a service account, or another microservice making an inter-service request may be the actor. At block 406, a relevant field-level access control policy for the identified actor may be retrieved. The field-level access control policy may determine an actor's permissions to access specific fields within data objects in the microservices architecture. In an example, each field-level access control policy is associated with several key attributes that define its scope and applicability. The attributes may include one or more of a tenant identifier, a set of caveats, a target resource type, and a field privilege.

At block 408, the retrieved relevant field-level access control policy for the identified actor may be evaluated against the request to determine a field-level access permission. The evaluated field-level access control policy may include a comprehensive set of permissions dictating which fields the identified actor can read or write within the specified resource type. This information may then be used by the system to enforce these permissions on incoming requests and outgoing responses.

At block 410, based on the determined field-level access permission, the request may be authorized to proceed to the microservice application logic. The authorization step may also help in maintaining the principle of least privilege. By carefully controlling which requests are allowed to proceed based on fine-grained field-level permissions, the risk of unauthorized data access or manipulation may be significantly reduced. Further, in scenarios where a request is not authorized to proceed, an appropriate error message may be provided.

Upon authorization, the microservice application logic may process the incoming request, which may involve retrieving data from databases, performing computations, or modifying existing data. The result of processing the request may include a response that contains the requested information or confirmation of the requested action. At block 412, before the generated response is sent back to the requesting actor, the response may be intercepted to ensure that the data being returned adheres to the access control policies defined for the specific actor making the request.

At block 414, the response may be filtered to remove fields that the actor lacks permission based on the determined field-level access permissions. The filtering technique ensures that even if unauthorized data is accidentally processed or retrieved, it may not reach the end-user or calling service, thus maintaining data security and privacy throughout the entire request-response cycle.

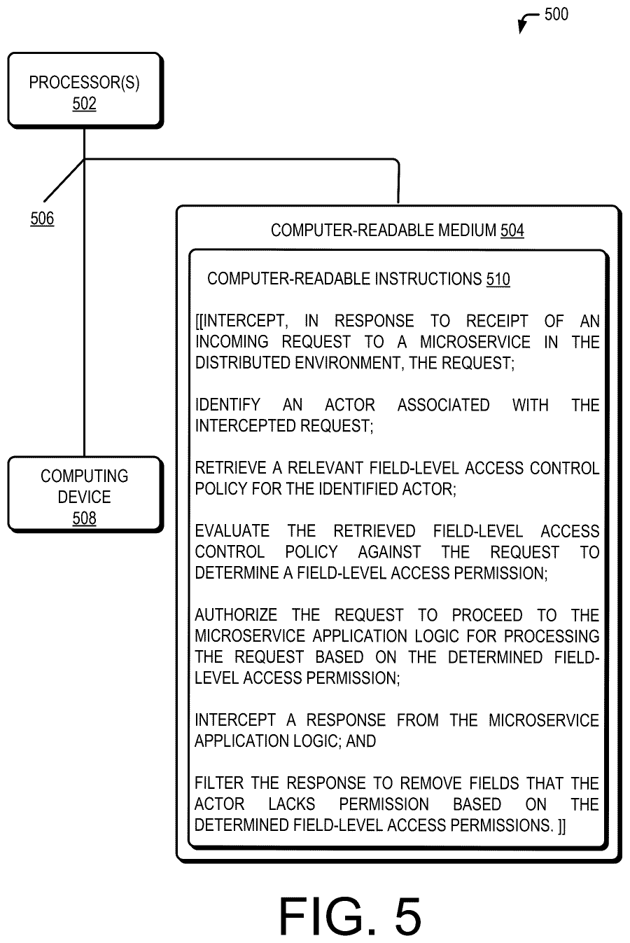

FIG. 5 illustrates a non-transitory computer-readable medium for orchestrating access control in a distributed environment, in accordance with an example of the present subject matter.

In an example, the computing environment 500 comprises processor(s) 502 communicatively coupled to a non-transitory computer-readable medium 504 through communication link 506. In an example, the computing environment 500 may be, for example, the system 100, 200. In an example, the processor(s) 502 may have one or more processing resources for fetching and executing computer-readable instructions 510 from the non-transitory computer-readable medium 504. The processor(s) 502 and the non-transitory computer-readable medium 504 may be implemented, for example, in the system 100, 200.

The non-transitory computer-readable medium 504 may be, for example, an internal memory device or an external memory. In an example, the communication link 506 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 504 comprises a set of computer-readable instructions 510 which may be accessed by the processor(s) 502 through the communication link 506 and subsequently executed for facilitating optimization of cellular network performance of the network element. The processor(s) 502 and the non-transitory computer-readable medium 504 may also be communicatively coupled to a system 100, 200 over the network. The processor(s) 502 and the non-transitory computer-readable medium 504 may also be communicatively coupled to a computing device 508 through the communication link 506.

Referring to FIG. 5, in an example, the non-transitory computer-readable medium 504 comprises computer-readable instructions 510 that cause the processor(s) 502 to intercept an incoming request received in a microservice in a distributed environment. The incoming request may include a read request or a write request or a combination of both, associated with an object.

In an example, the computer-readable instructions 510 may then cause the processor(s) 502 to identify an actor associated with the incoming request. For example, the actor may be an end-user, a service account, or another microservice making an inter-service request. A relevant field-level access control policy for the identified actor may then be retrieved. In an example, each field-level access control policy includes one or more of a tenant identifier, a set of caveats, a target resource type, and a field privilege.

The computer-readable instructions 510 may then cause the processor(s) 502 to evaluate the retrieved relevant field-level access control policy for the identified actor against the request to determine a field-level access permission. In an example, the field-level access permission may be indicative of the permitted fields which the identified actor can read or write within the specified resource type. Based on the determined field-level access permission, the request may be authorized to proceed to the microservice application logic.

In the example, the computer-readable instructions 510 may then cause the processor(s) 502 to intercept a response, generated by the microservice application logic, before the generated response is sent back to the requesting actor. The response may be intercepted to ensure that the data being returned adheres to the access control policies defined for the specific actor making the request. In an example, the response may be filtered to remove fields that the actor lacks permission based on the determined field-level access permissions.

Although examples of the present subject matter have been described in language specific to methods and/or structural features, it is to be understood that the present subject matter is not limited to the specific methods or features described. Rather, the methods and specific features are disclosed and explained as examples of the present subject matter.

1. A system for orchestrating access control in a distributed environment, the system comprising:
a processor to:
intercept, in response to receipt of an incoming request to a microservice in the distributed environment, the request; the request including at least one of a read request and a write request associated with an object, wherein the request is intercepted before reaching a microservice application logic;
identify an actor associated with the intercepted request;
retrieve a relevant field-level access control policy for the identified actor, the relevant field level access control policy being associated with one or more of a tenant identifier, a set of caveats, a target resource type, and a field privilege;
evaluate the retrieved field-level access control policy against the request to determine a field-level access permission;
authorize the request to proceed to the microservice application logic for processing the request based on the determined field-level access permission;
intercept a response from the microservice application logic, wherein the response is indicative of data retrieved or modified by the microservice application logic; and
filter the response to remove fields that the actor lacks permission based on the determined field-level access permissions.

2. The system of claim 1, wherein the processor is to:
inspect, for write request associated with the object, a payload of the request to determine the specific fields to be modified in response to the write request; and
reject the write request before it reaches the microservice application logic if the actor lacks permission to modify any of the determined specific fields.

3. The system of claim 1, wherein the processor is to:
maintain a distributed cache, wherein the distributed cache stores field-level access control policies specific to the microservice and the determined field-level access permissions based on evaluation of the field-level access control policy.

4. The system of claim 1, wherein the actor comprises at least one of an end-user, a service account, or another microservice making an inter-service request.

5. The system of claim 1, wherein the relevant field-level access control policy is retrieved from the distributed cache.

6. The system of claim 1, wherein the relevant field-level access control policy is retrieved from a policy management service when the relevant field-level access control policy is not available in the distributed cache; wherein the policy management service is a centralized repository for accessing field-level access control policies across the distributed environment.

7. The system of claim 1, wherein the caveats in the field access control policy are expressed in a proprietary caveat Domain-Specific Language (DSL) that enables definition of conditional read and write access to fields for the actor.

8. The system of claim 1, wherein the field privileges in each policy specify separate read and write access for individual fields of the target resource type.

9. A method for orchestrating access control in a distributed environment, the method comprising:
intercepting, in response to receipt of an incoming request to a microservice in the distributed environment, the request; the request including at least one of a read request and a write request associated with an object, wherein the request is intercepted before reaching a microservice application logic;
identifying an actor associated with the intercepted request;
retrieving a relevant field-level access control policy for the identified actor, the relevant field level access control policy being associated with one or more of a tenant identifier, a set of caveats, a target resource type, and a field privilege;
evaluating the retrieved field-level access control policy against the request to determine a field-level access permission;
authorizing the request to proceed to the microservice application logic for processing the request based on the determined field-level access permission;
intercepting a response from the microservice application logic, wherein the response is indicative of data retrieved or modified by the microservice application logic; and
filtering the response to remove fields that the actor lacks permission based on the determined field-level access permissions.

10. The method of claim 9, wherein to authorize the request to proceed to the microservice application logic for processing, the method comprising:
inspecting, for write request associated with the object, a payload of the request to determine the specific fields to be modified in response to the write request; and
rejecting the write request before it reaches the microservice application logic if the actor lacks permission to modify any of the determined specific fields.

11. The method of claim 9, wherein to retrieve the relevant field-level access control policy for the identified actor, the method comprising:
maintaining a distributed cache, wherein the distributed cache stores field-level access control policies specific to the microservice and the determined field-level access permissions based on evaluation of the field-level access control policy.

12. The method of claim 9, wherein the actor comprises at least one of an end-user, a service account, or another microservice making an inter-service request.

13. The method of claim 9, wherein the relevant field-level access control policy is retrieved from the distributed cache.

14. The method of claim 9, wherein the relevant field-level access control policy is retrieved from a policy management service when the relevant field-level access control policy is not available in the distributed cache; wherein the policy management service is a centralized repository for accessing field-level access control policies across the distributed environment.

15. The method of claim 9, wherein the caveats in the field access control policy are expressed in a proprietary caveat Domain-Specific Language (DSL) that enables definition of conditional read and write access to fields for the actor.

16. A non-transitory computer-accessible storage medium storing program comprising instructions for orchestrating access control in a distributed environment, the instructions being executable by a processor to:
intercept, in response to receipt of an incoming request to a microservice in the distributed environment, the request; the request including at least one of a read request and a write request associated with an object, wherein the request is intercepted before reaching a microservice application logic;
identify an actor associated with the intercepted request;
retrieve a relevant field-level access control policy for the identified actor, the relevant field level access control policy being associated with one or more of a tenant identifier, a set of caveats, a target resource type, and a field privilege;
evaluate the retrieved field-level access control policy against the request to determine a field-level access permission;
authorize the request to proceed to the microservice application logic for processing the request based on the determined field-level access permission;
intercept a response from the microservice application logic, wherein the response is indicative of data retrieved or modified by the microservice application logic; and
filter the response to remove fields that the actor lacks permission based on the determined field-level access permissions.

17. The non-transitory computer-accessible storage medium of claim 16, wherein to authorize the request to proceed to the microservice application logic for processing, the instructions cause the processor to:
inspect, for write request associated with the object, a payload of the request to determine the specific fields to be modified in response to the write request; and
reject the write request before it reaches the microservice application logic if the actor lacks permission to modify any of the determined specific fields.

18. The non-transitory computer-accessible storage medium of claim 16, wherein to retrieve the relevant field-level access control policy for the identified actor, the instructions cause the processor to:
maintain a distributed cache, wherein the distributed cache stores field-level access control policies specific to the microservice and the determined field-level access permissions based on evaluation of the field-level access control policy.

19. The non-transitory computer-accessible storage medium of claim 16, wherein the relevant field-level access control policy is retrieved from the distributed cache.

20. The non-transitory computer-accessible storage medium of claim 16, wherein the relevant field-level access control policy is retrieved from a policy management service when the relevant field-level access control policy is not available in the distributed cache; wherein the policy management service is a centralized repository for accessing field-level access control policies across the distributed environment.
